(19) United States
(12) Patent Application Publication
(10) Pub. No.: US 2024/0283189 A1
(43) Pub. Date: Aug. 22, 2024

(54) CONNECTOR AND METHOD OF MANUFACTURING CONNECTOR

(71) Applicant: YAZAKI CORPORATION, Tokyo (JP)

(72) Inventors: Seiji Kozono, Kakegawa-shi (JP); Yoshitaka Tsushima, Kakegawa-shi (JP); Masaya Okamoto, Kakegawa-shi (JP)

(21) Appl. No.: 18/653,979

(22) Filed: May 3, 2024

Related U.S. Application Data
(63) Continuation of application No. PCT/JP2023/004574, filed on Feb. 10, 2023.

(30) Foreign Application Priority Data
Feb. 21, 2022 (JP) 2022-025078

(51) Int. Cl. H01R 13/512; H01R 13/52

(52) U.S. Cl. CPC H01R 13/512; H01R 13/5202; H01R 13/5213; H01R 2201/26

(57) ABSTRACT

A connector includes a housing, a cover movable between a closed position and an open position, a packing configured to seal a gap between the cover and the housing when the cover is at the closed position, and a bearing component. The connector has a fixing structure capable of selecting a relative position of the bearing component in a direction along a plane intersecting a rotation shaft from a predetermined range and fixing the bearing component (60) to the selected position.

### CROSS-REFERENCE TO RELATED APPLICATIONS

This is a continuation of International Application No. PCT/JP2023/004574 filed on Feb. 10, 2023, and claims priority from Japanese Patent Application No. 2022-025078 filed on Feb. 21, 2022, the entire content of which is incorporated herein by reference.

### TECHNICAL FIELD

The present invention relates to a connector including a housing including an accommodating chamber capable of accommodating a terminal, a packing for sealing an opening portion of the accommodating chamber, a rotatable cover so as to open and close the opening portion of the accommodating chamber while holding the packing, and a bearing component supporting a rotation shaft of the cover, and relates to a method of manufacturing the connector.

### BACKGROUND ART

In related art, a power supply mounted on an automatic vehicle or the like or an electric wire for electrically connecting various electric components may be connected via a connector. Such connection is usually performed using a male connector and a female connector. For example, one of connectors in the related art is used in a charging inlet device for performing battery charging that is mounted on an electric automatic vehicle or the like, and an opening portion of a housing is sealed with a cover when not in use for a purpose of dustproof, terminal protection, electric shock prevention to the surroundings, and the like (for example, refer to Patent Literature 1). The cover is attached to the housing in a hinge shape, and is rotatable between a closed position where the cover is in close contact with the opening portion of the housing to close the opening portion and an open position where the cover is separated from the opening portion to open the opening portion.

### CITATION LIST

### Patent Literature

Patent Literature 1: JP2014-32901A

### SUMMARY OF INVENTION

### Technical Problem

In the above-described connector in the related art, a rubber sheet material (that is, a packing) is attached to the cover, and when the cover is at the closed position, the cover is engaged with the housing in a state where the sheet material is pressed against the opening portion of the housing, thereby sealing a gap between the cover and the housing. Here, depending on a degree of a shape variation due to manufacturing tolerance or the like of the housing, the cover, and the sheet material, there is a possibility that a position of the cover with respect to the housing is different from an optimum position (that is, ideal position in design) for sealing the gap described above. When such a positional deviation with respect to the optimum position occurs, there is a possibility that sealing performance of the sheet material deteriorates due to the reason that collapse of the sheet material when the cover is at the closed position is biased.

An object of the present invention is to provide a connector capable of appropriately sealing the gap between the housing and the cover by the packing, and a method of manufacturing the connector.

### Solution to Problem

In one aspect of the present invention, a connector includes:
a housing including an accommodating chamber including an opening portion opened to be capable of accommodating a terminal and receiving a counterpart terminal;
a cover movable between a closed position where the cover covers the opening portion and an open position where the cover opens the opening portion by rotating around a rotation shaft,
a packing configured to seal a gap between the cover and the housing when the cover is at the closed position; and
a bearing component supporting the rotation shaft, in which
the connector has a fixing structure capable of selecting a relative position of the bearing component with respect to the housing in a direction along a plane intersecting the rotation shaft from a predetermined range and fixing the bearing component to the selected position.

Further, in another aspect of the present invention, there is a method of manufacturing a connector, the connector including
a housing including an accommodating chamber including an opening portion opened to be capable of accommodating a terminal and receiving a counterpart terminal,
a cover movable between a closed position where the cover covers the opening portion and an open position where the cover opens the opening portion by rotating around a rotation shaft,
a packing configured to seal a gap between the cover and the housing when the cover is at the closed position, and
a bearing component supporting the rotation shaft, and the method of manufacturing the connector includes:
a step of supporting the rotation shaft of the cover by the bearing component; and
a step of selecting a relative position of the bearing component with respect to the housing in a direction along a plane intersecting the rotation shaft from a predetermined range and fixing the bearing component to the selected position.

### BRIEF DESCRIPTION OF DRAWINGS

FIG. 1 is a perspective view showing a connector and a counterpart connector according to an embodiment of the present invention.

FIG. 2 is an exploded perspective view of the connector shown in FIG. 1.

FIG. 3 is a perspective view of a cover shown in FIG. 2 as viewed from a rear side.

FIG. 4 is a perspective view showing a state in which the cover shown in FIG. 3 is disassembled and a packing is removed from the cover.

FIG. 5 is a view corresponding to an A-A cross section in FIG. 1, showing a positional relationship between the packing and an opening portion of a terminal accommodating chamber shown in FIG. 4 when the cover is at an open position.

FIG. 6 is a view corresponding to FIG. 5 when the cover is at a closed position.

FIG. 7 is a view showing a portion corresponding to a portion B in FIG. 2 for illustrating a first stage of an assembling procedure of the connector.

FIG. 8 is a view corresponding to FIG. 7 for illustrating a second stage of the assembling procedure of the connector.

FIG. 9 is a view corresponding to FIG. 7 for illustrating a third stage of the assembling procedure of the connector.

FIG. 10 is a view corresponding to FIG. 7 for illustrating a fourth stage of the assembling procedure of the connector.

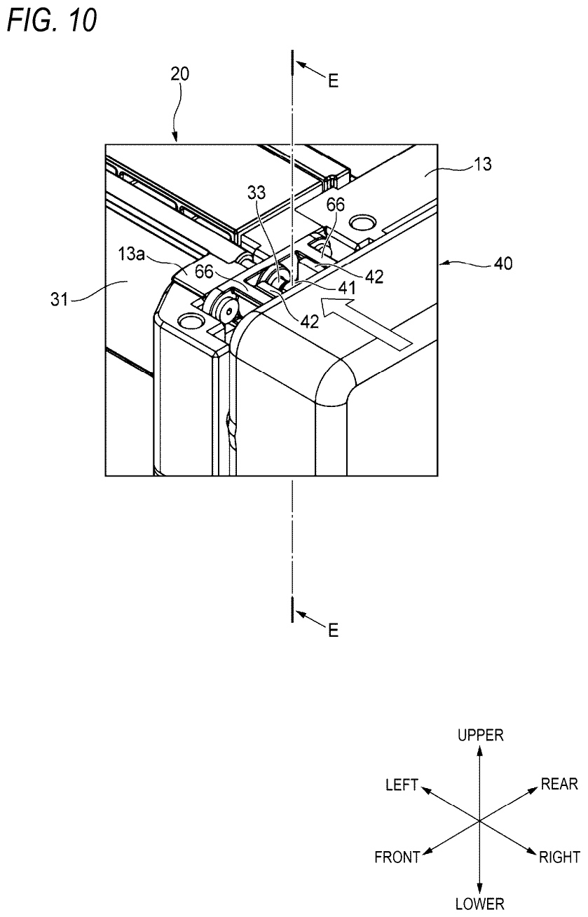

FIG. 11 is a cross-sectional view taken along a line C-C in FIG. 9.

FIG. 12 is a cross-sectional view taken along a line D-D in FIG. 9.

FIG. 13 is a cross-sectional view taken along a line E-E in FIG. 10.

### DESCRIPTION OF EMBODIMENTS

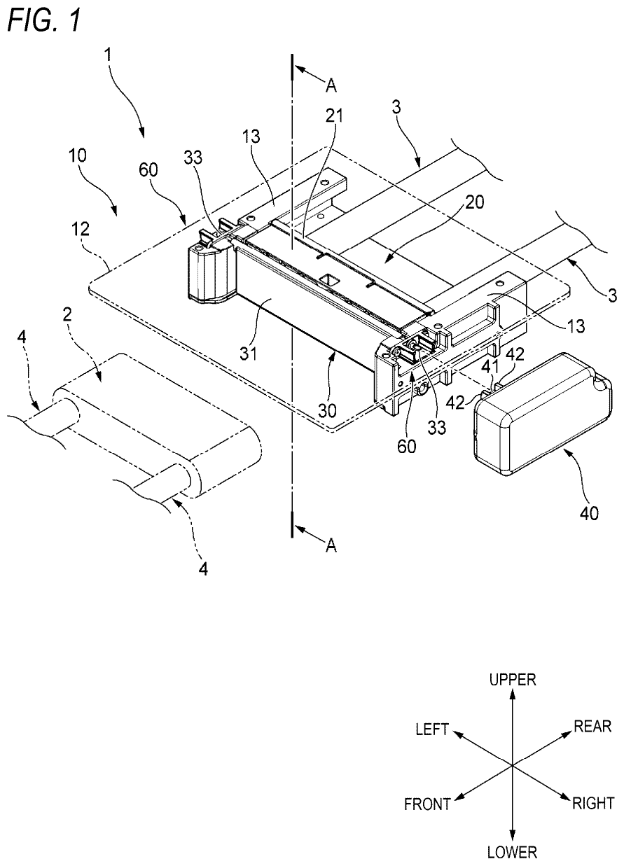

Hereinafter, a connector 1 according to an embodiment of the present invention shown in FIG. 1 will be described with reference to the drawings. The connector 1 is a typical charging inlet device mounted on an electric automatic vehicle or the like for battery charging. The connector 1 can be fitted with a counterpart connector 2 (see FIG. 1. A typical inlet plug). By fitting the connector 1 and the counterpart connector 2 with each other, a pair of electric wires 3 (see FIG. 1) connected to terminals (not shown) accommodated in a housing 20 (see FIG. 1) of the connector 1 and a pair of electric wires 4 (see FIG. 1) connected to counterpart terminals (not shown) accommodated in the counterpart connector 2 are electrically connected to each other.

Hereinafter, for convenience of description, as shown in FIG. 1 and the like, “front”, “rear”, “left”, “right”, “upper”, and “lower” are defined. A “front and rear direction”, a “left and right direction”, and an “upper and lower direction” are orthogonal to one another. The front and rear direction coincides with a fitting direction of the connector 1 and the counterpart connector 2. Note that these directions are defined for convenience of description, and do not necessarily correspond to the front and rear direction, the left and right direction, and the upper and lower direction of the vehicle when the connector 1 is mounted on a vehicle.

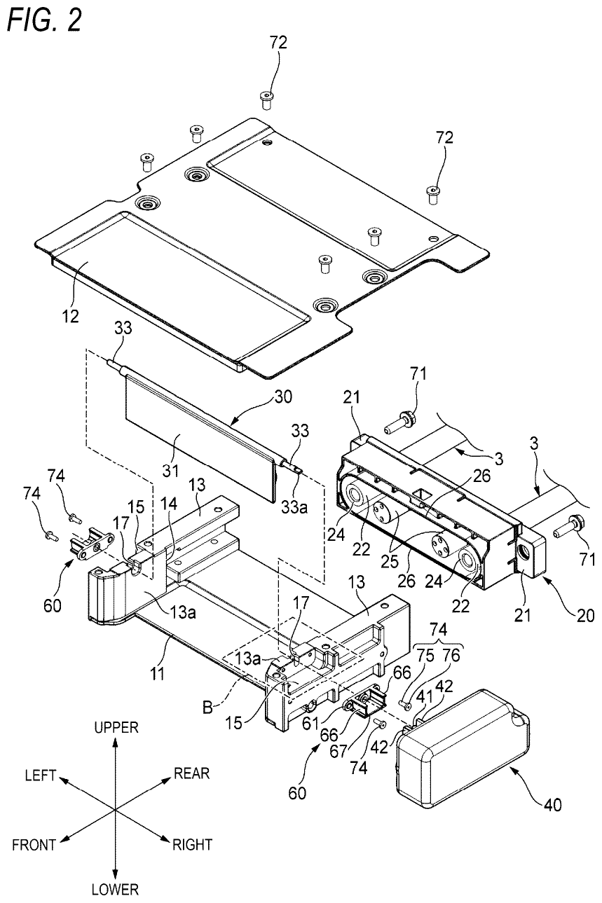

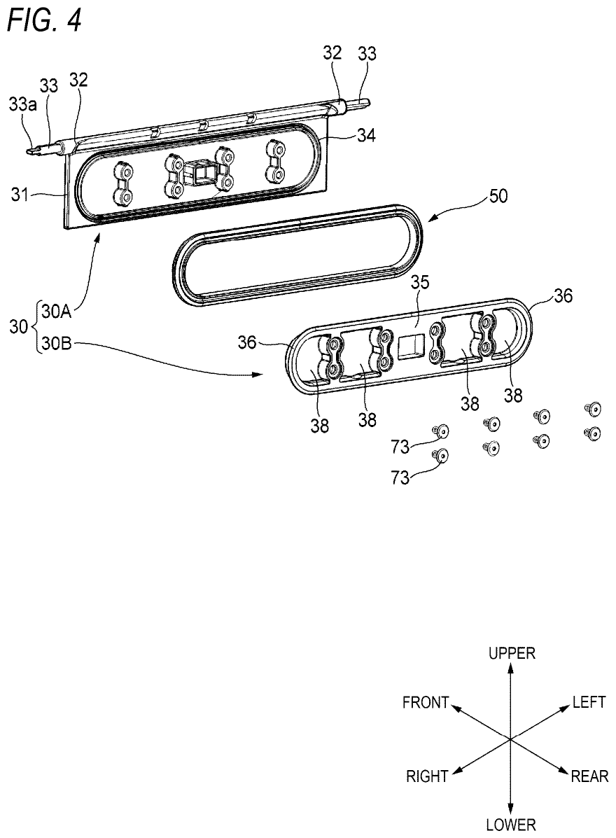

As shown in FIGS. 1 and 2, the connector 1 includes an outer case 10, the housing 20 accommodated in the outer case 10, a cover 30 rotatably supported by the outer case 10, an actuator 40 attached to the outer case 10 and rotationally driving the cover 30, a packing 50 (see FIG. 4) held by the cover 30, and a holder 60 attached to the outer case 10 and rotatably supporting the cover 30. Hereinafter, each component constituting the connector 1 will be described in order.

First, the outer case 10 will be described. The outer case 10 is a housing made of resin and constituting most of an external appearance of the connector 1. As shown in FIGS. 1 and 2, the outer case 10 includes a rectangular flat plate-shaped bottom plate 11, a substantially rectangular flat plate-shaped top plate 12 positioned above the bottom plate 11, and a pair of left and right support walls 13 fixed to a pair of left and right side edges of the bottom plate 11 and the top plate 12 and extending in the front and rear direction, and has a substantially rectangular tubular shape that penetrates in the front and rear direction.

As shown in FIG. 2, a pair of fixing faces (flat faces) 14 facing rearward are formed at substantially center positions in the front and rear direction on inner side faces in the left and right direction of the pair of support walls 13 facing each other in the left and right direction. The pair of fixing faces 14 function as portions for fixing both left and right end portions of a housing body 21 (see FIG. 2) of the housing 20 (see FIG. 1) to be described later.

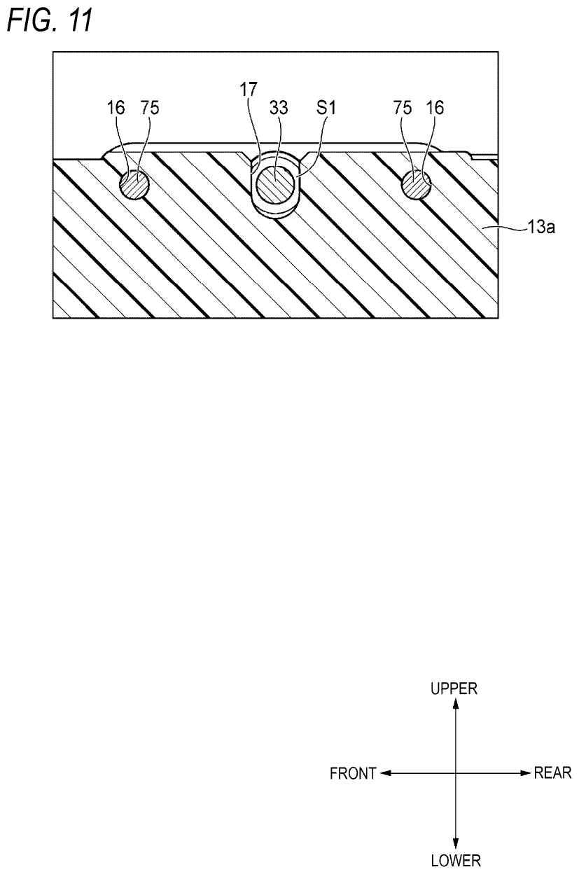

As shown in FIG. 2, a pair of recesses 15 extending in the front and rear direction are formed at corners on an upper side and an outer side in the left and right direction at positions in upper faces of the pair of support walls 13 in front of the fixing faces 14. Each recess 15 is a recess that is recessed downward and inward in the left and right direction and is open upward and outward in the left and right direction. The recess 15 functions as a portion for accommodating the holder 60. On an upper face of an adjacent portion 13a (see FIG. 2) adjacent to an inner side of the recessed portion 15 of each support wall 13 in the left and right direction, a groove 17 recessed downward and penetrating in the left and right direction is formed at a center position of the adjacent portion 13a in the front and rear direction. The groove 17 communicates with the recess 15. The pair of left and right grooves 17 function as portions allowing both end portions of a rotation shaft 33 (described later) of the cover 30 to be disposed (see FIG. 1). Here, as shown in FIG. 11, each of a width (in the front and rear direction) and a depth (in the upper and lower direction) of the groove 17 is larger than an outer diameter of the rotation shaft 33. That is, the grooves 17 and the rotation shaft 33 are designed such that a gap S1 is secured between an inner wall face of the groove 17 and an outer peripheral face of the rotation shaft 33 in a state where the end portions of the rotation shaft 33 are disposed in the grooves 17. An effect of securing such a gap S1 will be described later.

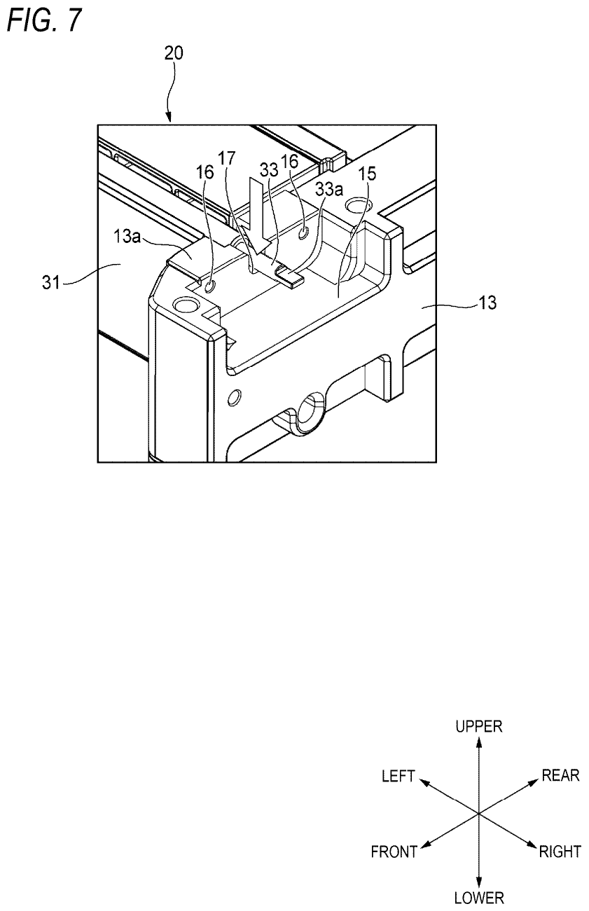

A pair of bolt holes 16 (see FIG. 7) are formed at a pair of positions sandwiching the groove 17 in the front and rear direction in an outer end face of the adjacent portion 13a of each support wall 13 in the left and right direction (a plane orthogonal to the left and right direction that defines an inner end of the recess 15 in the left and right direction). Each bolt hole 16 is a female screw hole recessed inward in the left and right direction. A pair of bolts 74 (see FIG. 2) described later for fastening and fixing the holder 60 are screwed into the pair of bolt holes 16.

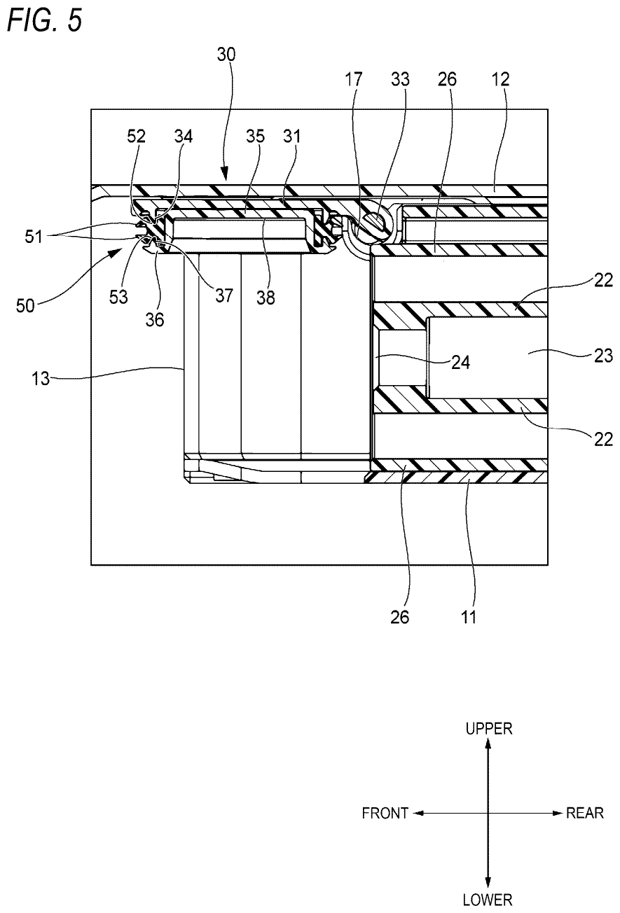

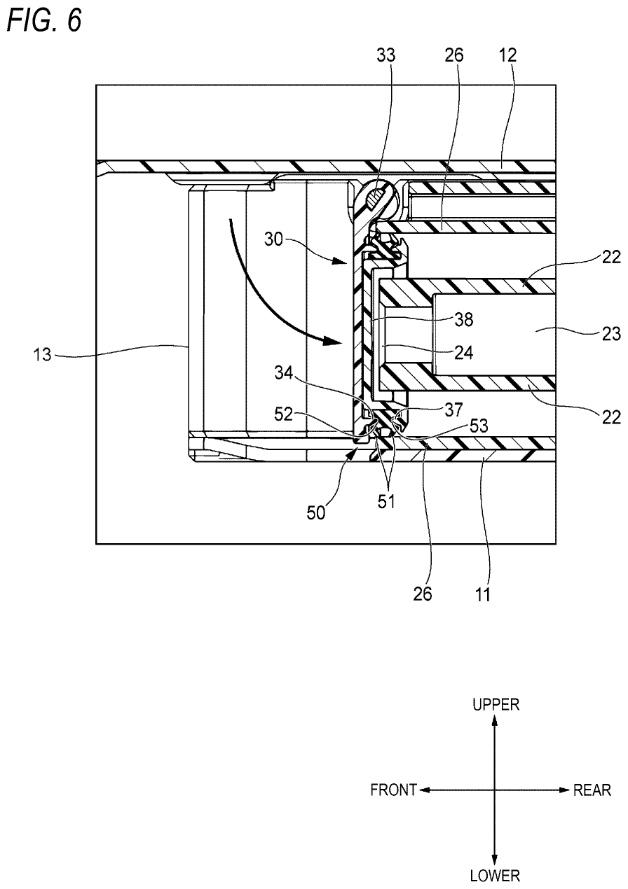

Next, the housing 20 will be described. As shown in FIG. 2, the housing 20 made of resin includes the elongated flat plate-shaped housing body 21 elongated in the left and right direction. The housing body 21 is integrally provided with a pair of cylindrical terminal accommodating cylindrical portions 22 projecting in the front and rear direction from both end portions of the housing body 21 in the left and right direction. A terminal accommodating chamber 23 penetrating in the front and rear direction is formed in the terminal accommodating cylindrical portion 22 (see FIGS. 5 and 6). A terminal (female terminal, not shown) connected to an end portion of the electric wire 3 (see FIG. 1) is inserted and fixed into the terminal accommodating chamber 23 from the rear.

An opening portion 24, which is a front end opening of the terminal accommodating chamber 23, is formed in a front end portion of the terminal accommodating cylindrical portion 22 (see FIGS. 2, 5, and 6). When the connector 1 and the counterpart connector 2 are fitted with each other, the counterpart terminal (male terminal) accommodated in the counterpart connector 2 is inserted into the terminal accommodating chamber 23 via the opening portion 24 and connected to the terminal (female terminal) positioned in the terminal accommodating chamber 23.

The housing body 21 is integrally provided with a pair of cylindrical projecting portions 25 that project forward from the housing body 21 at an interval in the left and right direction at positions inner than the pair of terminal accommodating cylindrical portions 22 in the left and right direction. Positions of front ends of the terminal accommodating cylindrical portions 22 in the front and rear direction coincide with positions of front ends of the projecting portions 25 in the front and rear direction. A plurality of terminal accommodating chambers (four in this example) are formed inside the projecting portion 25, and a plurality of opening portions (four in this example) corresponding to the respective terminal accommodating chambers are formed in a front end portion of the projecting portion 25. Similarly to the terminal accommodating chambers 23 of the terminal accommodating cylindrical portion 22, terminals connected to end portions of electric wires (not shown) are inserted and fixed from the rear into the respective terminal accommodating chambers of the projecting portions 25.

The housing body 21 is integrally provided with a cylindrical portion 26 having an oval shape elongated in the left and right direction when viewed from the front in a manner of projecting forward and collectively surrounding the pair of terminal accommodating cylindrical portions 22 and the pair of projecting portions 25 (that is, four cylindrical projecting portions aligned in the left and right direction). When the connector 1 and the counterpart connector 2 are fitted with each other, the counterpart connector 2 is inserted into an inner space of the cylindrical portion 26 via a front end opening of the cylindrical portion 26.

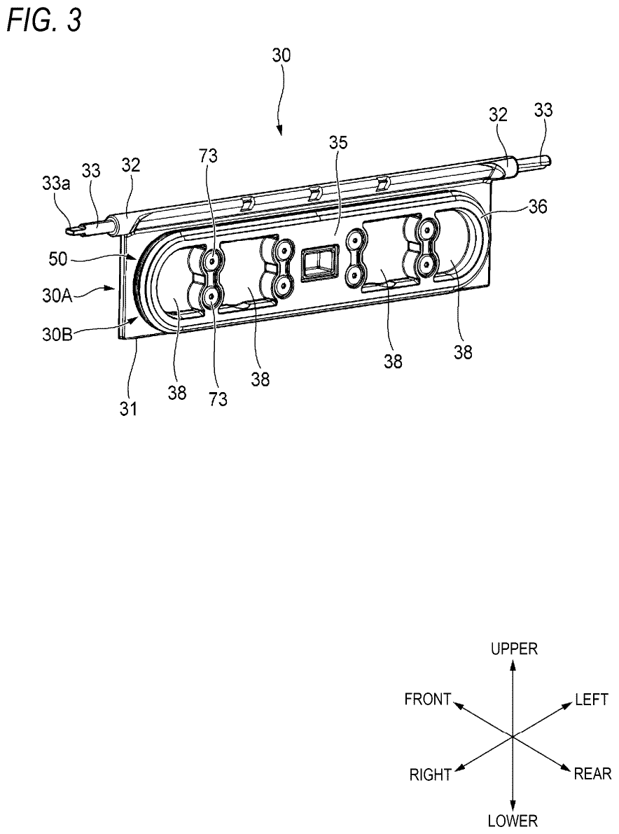

Next, the cover 30 will be described. The cover 30 is a component that holds the packing 50 (see FIGS. 3 and 4) and is supported by the outer case 10 so as to be rotatable together with the packing 50 between a closed position (see FIG. 6) where the cover 30 covers the opening portion 24 of the housing 20 and an open position (see FIG. 5) where the opening portion 24 is open.

As shown in FIGS. 3 and 4, the cover 30 includes a front cover 30A and a rear cover 30B. The front cover 30A and the rear cover 30B are assembled to each other such that the front cover 30A is disposed in front of the rear cover 30B (at the closed position of the cover 30) and the packing 50 is sandwiched and held between the front cover 30A and the rear cover 30B.

As shown in FIG. 4, the front cover 30A includes a substantially rectangular flat plate-shaped cover body 31 made of resin and elongated in the left and right direction. A pair of shaft-shaped portions 32 made of resin and projecting in both left and right directions are integrally provided on an upper edge portion of the cover body 31 (at the closed position of the cover 30) (see FIG. 4). A rod-shaped rotation shaft 33 made of metal and extending in the left and right direction is integrated with the front cover 30A by insert molding, such that the rotation shaft 33 continuously penetrates the upper edge portion of the cover body 31 and the pair of shaft-shaped portions 32 in the left and right direction, and such that both end portions of the rotation shaft 33 are exposed. The closed position of the cover 30 corresponds to a direction of the cover 30 in which the cover body 31 extends parallel to downward from the rotation shaft 33 (see FIG. 6), and the open position of the cover 30 corresponds to a direction of the cover 30 in which the cover body 31 extends parallel to forward from the rotation shaft 33 (see FIG. 5).

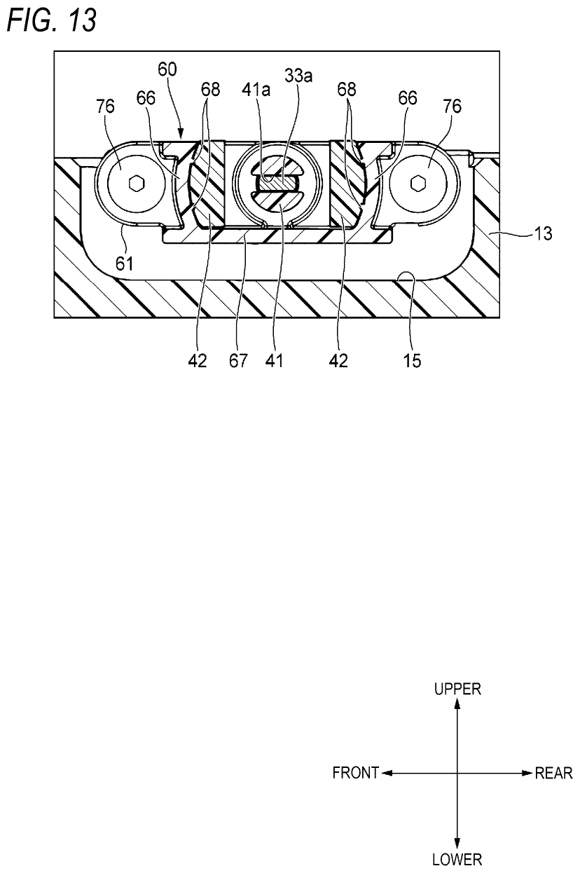

A flat plate-shaped engaging portion 33a is formed at a tip portion of a right end portion of the rotation shaft 33 (see FIGS. 2 to 4, and 13). The engaging portion 33a is engaged with a recessed engaged portion 41a provided corresponding to the engaging portion 33a at a tip portion of a drive shaft 41 of the actuator 40 (see FIG. 13).

On a rear end face (see FIG. 4) of the cover body 31 (at the closed position of the cover 30), an annular protrusion 34 that corresponds to the front end opening of the cylindrical portion 26 of the housing 20 and projects rearward is integrally provided in a manner of having an oval shape elongated in the left and right direction when viewed from the rear. When the cover 30 is assembled, the annular protrusion 34 is inserted into an annular groove 52 of the packing 50 (see FIGS. 5 and 6).

As shown in FIG. 4, the rear cover 30B includes a flat plate-shaped cover body 35 made of resin. The cover body 35 has an oval shape that corresponds to the front end opening of the cylindrical portion 26 of the housing 20 and is elongated in the left and right direction when viewed from the rear. On a rear end portion of an outer peripheral face of the cover body 35 (at the closed position of the cover 30), an annular flange portion 36 projecting outward over an entire periphery of the corresponding outer peripheral face is integrally provided (see FIGS. 4 to 6). On a front end face of the annular flange portion 36 (at the closed position of the cover 30), an annular protrusion 37 that corresponds to the front end opening of the cylindrical portion 26 of the housing 20 and projects forward is integrally provided in a manner of having an oval shape elongated in the left and right direction when viewed from the front. When the cover 30 is assembled, the annular protrusion 37 is inserted into an annular groove 53 of the packing 50 (see FIGS. 5 and 6).

Four circular recesses 38, which correspond to the pair of terminal accommodating cylindrical portions 22 and the pair of projecting portions 25 (that is, the four cylindrical projecting portions aligned in the left and right direction) of the housing 20 and are aligned in the left and right direction, are formed in a rear end face (see FIG. 4) of the cover body 35 (at the closed position of the cover 30). When the cover 30 is at the closed position, the four recesses 38 function as escape portions for avoiding interference with tip portions of the pair of terminal accommodating cylindrical portions 22 and the pair of projecting portions 25 (that is, the four cylindrical projecting portions aligned in the left and right direction) (see FIG. 6).

As shown in FIG. 4, the packing 50 held by the cover 30 is an annular rubber seal member having an oval shape that corresponds to the front end opening of the cylindrical portion 26 of the housing 20 and is elongated in the left and right direction when viewed in the front and rear direction. When the cover 30 is in the closed position, the packing 50 has a function of covering the opening portions 24 of the terminal accommodating cylindrical portions 22 of the housing 20 and tip faces of the projecting portions 25 in order to implement dustproof, terminal protection, electric shock prevention to the surroundings, and the like.

On an outer peripheral face of the packing 50, a pair of annular lip portions 51 projecting outward over the entire periphery of the packing 50 are integrally provided in a manner of being aligned in the front and rear direction (at the closed position of the cover 30) (see FIGS. 5 and 6). The annular lip portions 51 have a function of sealing a gap between the cover 30 and the housing 20 by contacting and pressing an inner wall face of the cylindrical portion 26 of the housing 20 at the closed position of the cover 30 (see FIG. 6). The annular groove 52 is formed on a front side face of the packing 50 (at the closed position of the cover 30), and the annular groove 53 is formed on a rear side face of the packing 50 (at the closed position of the cover 30).

In order to assemble the cover 30, first, the packing 50 is assembled to the rear cover 30B. Specifically, the packing 50 is attached to the outer peripheral face of the cover body 35 such that the annular protrusion 37 is inserted into the annular groove 53 of the packing 50. Next, the rear cover 30B to which the packing 50 is assembled is assembled to the front cover 30A. Specifically, the cover body 31 and the cover body 35 are fastened and fixed to each other by a plurality of bolts 73 (see FIG. 4) in a state where the cover body 35 to which the packing 50 is assembled is superimposed on the cover body 31 from the rear such that the annular protrusion 34 is inserted into the annular groove 52 of the packing 50. Accordingly, the assembly of the cover 30 is completed. In the state where the assembly of the cover 30 is completed, as shown in FIGS. 5 and 6, the packing 50 is held by the cover 30 in a manner of being sandwiched in the front and rear direction by the annular protrusions 34 and 37 disposed to face each other in the front and rear direction (at the closed position of the cover 30). Accordingly, the packing 50 is prevented from being separated from the cover 30.

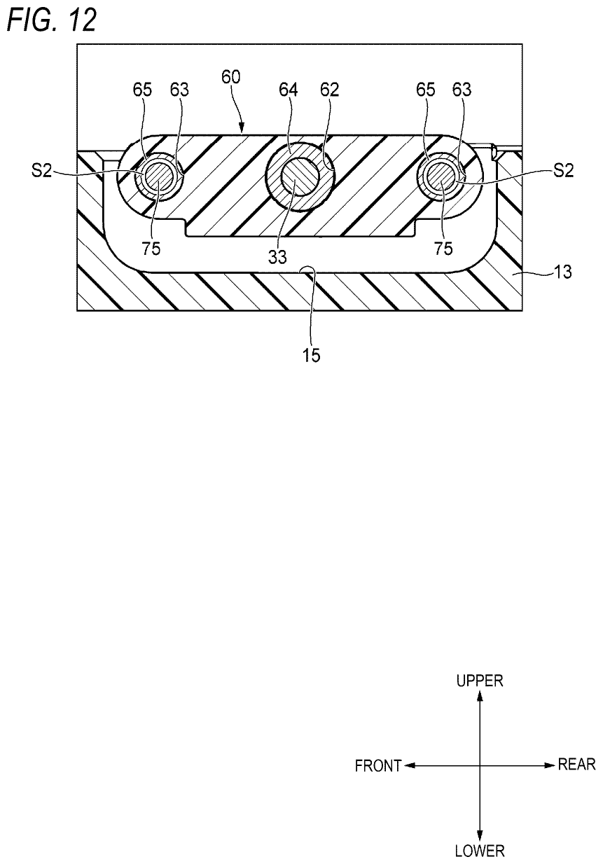

Next, the holder 60 will be described. As shown in FIGS. 1 and 2, the holder 60 is a component that is attached to each of the pair of recesses 15 of the outer case 10 and rotatably supports the cover 30. As shown in FIGS. 2, 8, and 12, the holder 60 made of resin includes a flat plate-shaped substrate portion 61 extending in the front and rear direction. As shown in FIG. 12, a shaft insertion hole 62 is formed in a manner of penetrating the substrate portion 61 in the left and right direction (plate thickness direction) at a center portion in the front and rear direction. A cylindrical bearing 64 made of metal is attached to the shaft insertion hole 62. A tip portion of the rotation shaft 33 of the cover 30 is inserted into the bearing 64 (see FIG. 12).

A pair of front and rear through holes 63 corresponding to the pair of front and rear bolt holes 16 (see FIG. 7 and the like) of the outer case 10 are formed at a pair of positions sandwiching the shaft insertion hole 62 (bearing 64) in the front and rear direction in the manner of penetrating the substrate portion 61 in the left and right direction (plate thickness direction). A shaft portion 75 (see FIG. 2) of a bolt 74 is inserted into the through hole 63 (see FIG. 12). As shown in FIG. 12, a cylindrical collar 65 made of metal is attached to the through hole 63. Here, as shown in FIG. 12, an inner diameter of the collar 65 is larger than an outer diameter of the shaft portion 75 of the bolt 74. That is, in a state where the shaft portion 75 of the bolt 74 is inserted into the collar 65, the collar 65 and the shaft portion 75 are designed such that a gap S2 is secured between an inner wall face of the collar 65 and an outer peripheral face of the shaft portion 75. A size of the gap S2 is slightly smaller than a size of the above-described gap S1 (see FIG. 11). An effect of securing such a gap S2 will be described later. As shown in FIG. 12, an inner diameter of the bearing 64 is substantially the same as the outer diameter of the rotation shaft 33. That is, in a state where the rotation shaft 33 is inserted into the bearing 64, a gap is hardly secured between an inner wall face of the bearing 64 and the outer peripheral face of the rotation shaft 33.

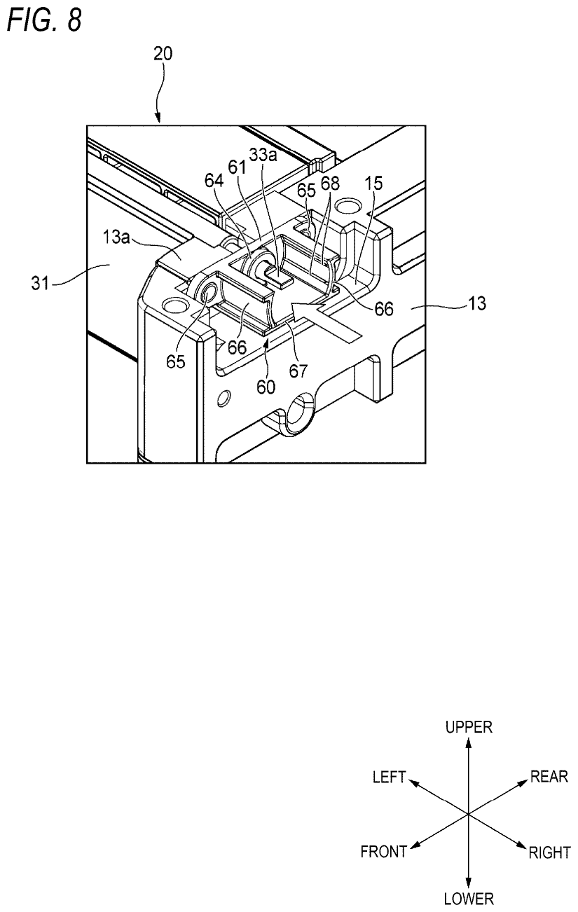

The substrate portion 61 is integrally provided with a pair of wall portions 66 projecting outward in the left and right direction from a pair of front and rear positions each between the shaft insertion hole 62 and the through hole 63, and a wall portion 67 projecting outward in the left and right direction and connecting lower end portions of the pair of wall portions 66 in the front and rear direction (see FIGS. 2, 8, and 13). As shown in FIG. 13, each wall portion 66 has an arc shape projecting outward in the front and rear direction when viewed in the left and right direction. Protruding portions 68 extending in the left and right direction are formed at two positions in the upper and lower direction on respective inner side faces of the wall portions 66 in the front and rear direction (faces of the pair of wall portions 66 facing each other) (see FIGS. 8 and 13). An effect of such a protruding portion 68 will be described later. The components constituting the connector 1 are described above.

Next, an assembling procedure of the connector 1 will be described. First, as shown in FIG. 2, the pair of support walls 13 are fastened and fixed to the pair of left and right side edges of the upper face of the bottom plate 11 by bolts (not shown). Next, the housing 20 for accommodating the pair of terminals (not shown) connected to the end portions of the pair of electric wires 3 (see FIGS. 1 and 2) is fixed to the pair of support walls 13 at a position between the pair of support walls 13. Specifically, front end faces of the both end portions of the housing body 21 in the left and right direction are fastened and fixed to the fixing faces 14 of the pair of support walls 13 by the pair of bolts 71 (see FIG. 2).

Next, the cover 30 holding the packing 50 is rotatably supported by the outer case 10. Specifically, first, as shown in FIG. 7, both end portions of the rotation shaft 33 of the cover 30 are accommodated and supported in the grooves 17 of the pair of support walls 13 from above such that the tip portions thereof are positioned in the pair of recesses 15 (see a white arrow in FIG. 7). In this state, due to the presence of the above-described gap S1 (see FIG. 11), a relative position of the rotation shaft 33 with respect to the outer case 10 (support wall 13) in directions orthogonal to the left and right direction can be freely adjusted within a range of the gap S1.

Next, as shown in FIG. 8, the pair of holders 60 are attached to the recesses 15 of the pair of support walls 13. Specifically, each holder 60 is attached to the recess 15 from the outside in the left and right direction such that the end portion of the rotation shaft 33 positioned in the recess 15 is inserted into the bearing 64, and such that the substrate portion 61 comes into contact with an inner end face of the recess 15 in the left and right direction (see a white arrow in FIG. 8). In this state, the tip portion of the rotation shaft 33 (particularly, the engaging portion 33a at the tip portion on the right) is positioned between the pair of wall portions 66 of the holder 60.

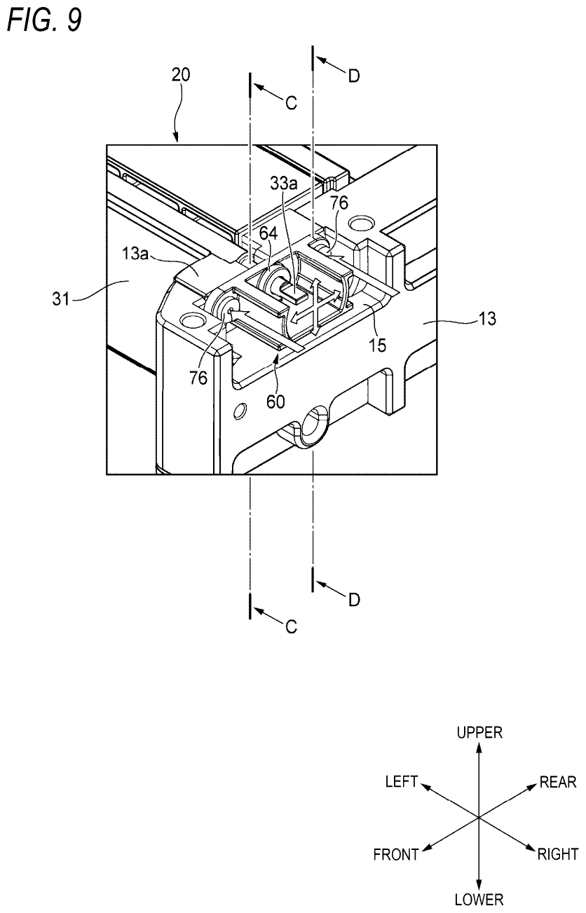

Next, as shown in FIG. 9, each holder 60 is temporarily fixed to the recess 15 using the pair of bolts 74. Specifically, with respect to each holder 60, the shaft portions 75 of the pair of bolts 74 are inserted into the pair of collars 65 and the pair of bolt holes 16 of the outer case 10 in this order from the outside in the left and right direction, and are screwed into the pair of bolt holes 16 with weak torque, so that each holder 60 is temporarily fixed (see thick white arrows in FIG. 9). In this state, due to the presence of the above-described gaps S1 (see FIG. 11) and S2 (see FIG. 12), a relative position of the holder 60 with respect to the outer case 10 (support wall 13, housing 20) in the directions orthogonal to the left and right direction can be freely adjusted within a range of the gap S2.

Next, the relative position of the holder 60 with respect to the outer case 10 is adjusted such that the rotation shaft 33 of the cover 30 is positioned at a position suitable for the packing 50 held by the cover 30 sealing the gap between the cover 30 and the housing 20. Specifically, in a state where the cover 30 is maintained at the closed position (that is, a state where the annular lip portion 51 of the packing 50 contacts and presses the inner wall face of the cylindrical portion 26 to seal the gap between the cover 30 and the housing 20), the relative position of the holder 60 with respect to the outer case 10 in the directions orthogonal to the left and right direction is adjusted within the range of the gap S2, so that the rotation shaft 33 of the cover 30 is positioned at a position at which a repulsive force exerted on the cover 30 by the packing 50 is balanced (see thin white arrows in FIG. 9). This adjustment may be performed by, for example, utilizing a fact that the repulsive force exerted on the cover 30 by the packing 50 is naturally balanced, or may be manually performed while an operator visually checks the position of the cover 30.

Next, in a state where the relative position of the holder 60 with respect to the outer case 10 is held at the adjusted position described above, the pair of bolts 74 are respectively fastened by specified torque. When the fastening operation is performed, the presence of the pair of wall portions 66 of the holder 60 can prevent a tool or the like from erroneously contacting the rotation shaft 33 of the cover 30. By this fastening, the substrate portion 61 of the holder 60 is pressed and sandwiched between head portions 76 of the pair of bolts 74 and the inner end faces of the recess 15 in the left and right direction, so that the relative position of the holder 60 with respect to the outer case 10 is fixed to the adjusted position described above. Accordingly, regardless of a size of a shape variation of the housing 20, the cover 30, and the packing 50, the cover 30 is in a state of being rotatable together with the packing 50 between the closed position (see FIG. 6) and the open position (see FIG. 5) while maintaining a state where the position of the cover 30 with respect to the housing 20 at the closed position of the cover 30 (see FIG. 6) is fixed to the position suitable for sealing the gap between the cover 30 and the housing 20.

Next, the top plate 12 is fastened and fixed to the upper faces of the pair of support walls 13 by a plurality of bolts 72 (see FIG. 2). Accordingly, the outer case 10 having a substantially rectangular cylindrical shape penetrating in the front and rear direction is completed (see FIG. 1). The housing 20 is accommodated in an inner space of the completed outer case 10, and the cover 30 is rotatably accommodated therein.

Next, as shown in FIG. 1, the actuator 40 is attached to the outer case 10. The actuator 40 is a typical electric motor including the drive shaft 41 (see FIG. 1). As shown in FIGS. 1 and 13, the actuator 40 includes the drive shaft 41 extending in the left and right direction and projecting leftward, and a pair of wall portions 42 corresponding to the pair of wall portions 66 of the holder 60 and projecting leftward from a pair of positions sandwiching the drive shaft 41 in the front and rear direction.

The actuator 40 is attached to an outer side face of the right support wall 13 from the right, such that the pair of wall portions 42 are positioned inside the pair of wall portions 66, and such that the engaging portion 33a of the rotation shaft 33 is engaged with the recessed engaged portion 41a provided at a tip portion of the drive shaft 41 (see FIG. 13). At this time, (the pair of wall portions 42 of) the actuator 40 can be guided to an appropriate position by the pair of wall portions 66 of the holder 60 and the protruding portions 68 (see FIG. 13) provided on the wall portions 66. Due to the engagement between the engaged portion 41a and the engaging portion 33a, the rotation shaft 33 and the drive shaft 41 are connected to each other so as to rotate integrally. Accordingly, by electrically controlling the actuator 40, the cover 30 can be rotationally driven between the closed position (see FIG. 6) and the open position (see FIG. 5). As described above, the assembly of the connector 1 is completed.

When the connector 1 and the counterpart connector 2 are not fitted with each other, the cover 30 is maintained at the closed position (see FIG. 6). Accordingly, the cover 30 covers the opening portion 24 while the annular lip portion 51 of the packing 50 seals the gap between the cover 30 and the housing 20, so that dustproof, terminal protection, electric shock prevention to the surroundings, and the like are implemented. On the other hand, when the connector 1 and the counterpart connector 2 are fitted with each other, the cover 30 is maintained at the open position (see FIG. 5). Accordingly, the pair of opening portions 24 are opened, and the pair of counterpart terminals (male terminals) accommodated in the counterpart connector 2 are in a state of capable of inserting into the terminal accommodating chambers 23 via the opening portions 24.

As described above, according to the connector 1 and the method of manufacturing the connector 1 of the present embodiment, the connector 1 includes the holders 60 that support the rotation shaft 33 of the cover 30. Further, the connector 1 has a fixing structure capable of selecting the relative position of the holder 60 with respect to the housing 20 in a direction along a plane intersecting the rotation shaft 33 from a predetermined range (within the range of the gap S2) and fixing the holder 60 to the selected position. Accordingly, when manufacturing the connector 1, the holder 60 can be fixed after adjusting the position of the holder 60 (that is, while performing positioning) such that the cover 30 and the packing 50 are positioned at the position suitable for sealing the gap between the cover 30 and the housing 20 (for example, a position at which the repulsive force exerted on the cover 30 by the packing 50 is balanced when the cover 30 is at the closed position). As a result, the position of the cover 30 with respect to the housing 20 can be set to the position suitable for sealing the gap between the cover 30 and the housing 20 regardless of the size of the shape variation of the housing 20, the cover 30, and the packing 50. Accordingly, the connector 1 according to the present embodiment can appropriately seal the gap between the housing 20 and the cover 30 by the packing 50.

Further, the holder 60 includes the bearing 64 into which the rotation shaft 33 is inserted and the collars 65 into which the bolts 74 are inserted. There is the gap S2 (see FIG. 12) between the shaft portion 75 of the bolt 74 and the inner wall face of the collar 65 facing the shaft portion 75, and the holder 60 is fixed by pressing the holder 60 with the head portions 76 of the bolts 74 at the time of fastening. Accordingly, the above-described fixing structure is implemented.

Further, the holder 60 includes the wall portions 66 each disposed between the bearing 64 and the collar 65 and standing in a direction along the bearing 64. Accordingly, when the bolts 74 are inserted into the collars 65 to perform the fastening operation, it is possible to prevent a tool or the like from erroneously contacting the rotation shaft 33 of the cover 30.

Further, the wall portion 66 includes the protruding portions 68 projecting from a side face facing the bearing 64. Accordingly, when the actuator 40 that rotationally drives the rotation shaft 33 of the cover 30 is attached to the rotation shaft 33, the actuator 40 can be guided to an appropriate position by the wall portions 66 and the protruding portions 68.

The present invention is not limited to the embodiment described above and various modifications can be adopted within the scope of the present invention. For example, the present invention is not limited to the embodiment described above, and modifications, improvements, and the like can be made as appropriate. In addition, materials, shapes, sizes, numbers, arrangement positions, and the like of components in the embodiment described above are freely selected and are not limited as long as the present invention can be implemented.

In the above embodiment, the holder 60 includes the wall portions 66 each disposed between the bearing 64 and the collar 65 and standing in the direction along the bearing 64. In contrast, the holder 60 may not include such wall portions.

Further, in the above embodiment, the wall portions 66 of the holder 60 include the protruding portions 68 projecting from the side face facing the bearing 64. In contrast, the wall portions 66 of the holder 60 may not have such protruding portions.

Further, in the above-described embodiment, the shaft portions 75 of the bolts 74 are inserted into the cylindrical collars 65 (that is, the through holes) attached to the through holes 63 of the holder 60. In contrast, instead of such holes, a groove, a slit, or the like penetrating the substrate portion 61 of the holder 60 in the left and right direction may be provided, and the shaft portions 75 of the bolts 74 may be inserted into the groove, the slit, or the like.

Here, in the embodiment of the present invention described above, the connector (1) includes:
the housing (20) including the accommodating chamber (23) including the opening portions (24) opened to be capable of accommodating the terminal and receiving the counterpart terminal;
the cover (30) movable between the closed position where the cover (30) covers the opening portions (24) and the open position where the cover (30) opens the opening portions (24) by rotating around the rotation shaft (33);
the packing (50) sealing the gap between the cover (30) and the housing (20) when the cover (30) is at the closed position; and
bearing components (60) supporting the rotation shaft (33), in which
the connector (1) has the fixing structure capable of selecting a relative position of the bearing component (60) with respect to the housing (20) in a direction along a plane intersecting the rotation shaft (33) from the predetermined range (S2) and fixing the bearing component (60) to the selected position.

According to the connector having the configuration described above, the connector includes the bearing component that supports the rotation shaft of the cover. Further, the connector has the fixing structure capable of selecting the relative position of the bearing component with respect to the housing in the direction along the plane intersecting the rotation shaft from the predetermined range and fixing the bearing component to the selected position. The “selection” of the position of the bearing component may be, for example, a selection of the position by utilizing the fact that the repulsive force exerted on the cover by the packing is naturally balanced when the cover in a state where the bearing component is attached to the rotation shaft and the bearing component is not yet fixed (hereinafter, also referred to as a cover before fixing) is disposed at the closed position, or a selection of the position by an operator manually adjusting the position of the cover before fixing while visually checking the position of the cover before fixing. That is, the selection of the position of the bearing component can also be referred to as “positioning” of the bearing component.

Therefore, when manufacturing the connector, the bearing component can be fixed after adjusting the position of the bearing component (that is, while performing positioning) such that the cover and the packing are positioned at the position suitable for sealing the gap (for example, the position at which the repulsive force exerted on the cover by the packing is balanced when the cover is at the closed position). As a result, the position of the cover with respect to the housing can be set to the position suitable for sealing the gap regardless of the size of the shape variation of the housing, the cover, and the packing. Therefore, the connector having the present configuration can appropriately seal the gap between the housing and the cover by the packing.

Further, the connector (1) may further include
the bolts (74) configured to fasten and fix the bearing components (60), in which
the bearing component (60) may include the bearing portion (64) into which the rotation shaft (33) is inserted and bolt insertion portions (65) into which the bolts (74) are inserted, and
the fixing structure may include the shaft portions (75) of the bolts (74), the gap (S2) provided between the shaft portion (75) and the inner wall face of the bolt insertion portion (65) facing the shaft portion (75) and having a width corresponding to the range, and the head portions (76) of the bolts (74) for pressing and fixing the bearing component (60) when the bolts (74) are fastened.

According to the connector having the configuration described above, the bearing component includes the bearing portion into which the rotation shaft is inserted and the bolt insertion portions into which the bolts are inserted. Between the shaft portion of the bolt and the inner wall face of the bolt insertion portion facing the shaft portion, there is a gap having a width corresponding to the range of positioning the bearing component described above, and the bearing component is fixed by pressing the bearing component with the head portions of the bolts at the time of fastening. Accordingly, the above-described fixing structure can be implemented.

Further, the bearing component (60) may further include
the wall portions (66) each disposed between the bearing portion (64) and the bolt insertion portion (65) and standing in the direction along the bearing portion (64).

According to the connector having the configuration described above, the bearing component includes the wall portions each disposed between the bearing portion and the bolt insertion portion and standing in the direction along the bearing portion. Accordingly, when the bolt is inserted into the bolt insertion portion to perform the fastening operation, it is possible to prevent a tool or the like from erroneously contacting the rotation shaft of the cover.

Further, the wall portion (66) may include
the protruding portions (68) projecting from the side face facing the bearing portion (64).

According to the connector having the configuration described above, the wall portion includes the protruding portions projecting from the side face facing the bearing portion. Accordingly, for, example, when the actuator (such as a motor) that rotationally drives the rotation shaft of the cover is attached to the rotation shaft, the actuator can be guided to an appropriate position by the wall portions and the protruding portions.

In addition, in the embodiment of the present invention described above, there is a method of manufacturing the connector (1) including
the housing (20) including the accommodating chamber (23) including the opening portions (24) opened to be capable of accommodating the terminal and receiving the counterpart terminal,
the cover (30) movable between the closed position where the cover (30) covers the opening portions (24) and the open position where the cover (30) opens the opening portions (24) by rotating around the rotation shaft (33),
the packing (50) sealing the gap between the cover (30) and the housing (20) when the cover (30) is at the closed position, and
bearing components (60) supporting the rotation shaft (33), and the method of manufacturing the connector (1) includes:
a step of supporting the rotation shaft (33) of the cover (30) by the bearing components (60); and
a step of selecting a relative position of the bearing component (60) with respect to the housing (20) in the direction along the plane intersecting the rotation shaft (33) from the predetermined range (S2) and fixing the bearing component (60) to the selected position.

According to the method of manufacturing the connector having the configuration described above, the connector includes the bearing components that support the rotation shaft of the cover. Further, the connector has the fixing structure capable of selecting the relative position of the bearing component with respect to the housing in the direction along the plane intersecting the rotation shaft from the predetermined range and fixing the bearing component to the selected position. Accordingly, when manufacturing the connector, the bearing component can be fixed after adjusting the position of the bearing component (that is, while performing positioning) such that the rotation shaft of the cover is positioned at a position suitable for sealing the gap (for example, a position at which the repulsive force exerted on the cover by the packing is balanced when the cover is at the closed position). As a result, the position of the cover with respect to the housing can be set to the position suitable for sealing the gap regardless of the size of the shape variation of the housing, the cover, and the packing. Therefore, according to the method of manufacturing the connector having the present configuration, a connector capable of appropriately sealing the gap between the housing and the cover by the packing can be obtained.

The present application is based on a Japanese patent application (Japanese Patent Application No. 2022-025078) filed on Feb. 21, 2022, and the contents thereof are incorporated herein by reference.

### INDUSTRIAL APPLICABILITY

The connector and the method of manufacturing the connector of the present invention can appropriately seal the gap between the housing and the cover by the packing. The present invention having this effect can be used in, for example, a charging inlet device for performing battery charging mounted on an electric automatic vehicle or the like.

### REFERENCE SIGNS LIST

1: connector
20: housing
23: terminal accommodating chamber (accommodating chamber)
24: opening portion
30: cover
33: rotation shaft
50: packing
60: holder (bearing component)
64: bearing (bearing portion)
65: collar (bolt insertion portion)
66: wall portion
68: protruding portion
74: bolt
75: shaft portion
76: head portion
S2: gap

1. A connector comprising:
a housing including an accommodating chamber including an opening portion opened to be capable of accommodating a terminal and receiving a counterpart terminal;
a cover movable between a closed position where the cover covers the opening portion and an open position where the cover opens the opening portion by rotating around a rotation shaft,
a packing configured to seal a gap between the cover and the housing when the cover is at the closed position; and
a bearing component supporting the rotation shaft, wherein
the connector has a fixing structure capable of selecting a relative position of the bearing component with respect to the housing in a direction along a plane intersecting the rotation shaft from a predetermined range and fixing the bearing component to the selected position.

2. The connector according to claim 1, further comprising:
a bolt configured to fasten and fix the bearing component, wherein
the bearing component includes a bearing portion into which the rotation shaft is inserted and a bolt insertion portion into which the bolt is inserted, and
the fixing structure includes a shaft portion of the bolt, a gap provided between the shaft portion and an inner wall face of the bolt insertion portion facing the shaft portion and having a width corresponding to the range, and a head portion of the bolt configured to press and fix the bearing component when the bolt is fastened.

3. The connector according to claim 2, wherein
the bearing component further includes a wall portion disposed between the bearing portion and the bolt insertion portion and standing in a direction along the bearing portion.

4. The connector according to claim 3, wherein
the wall portion includes a protruding portion projecting from a side face facing the bearing portion.
